(19) United States
(12) Patent Application Publication
(10) Pub. No.: US 2026/0106832 A1
(43) Pub. Date: Apr. 16, 2026

(54) METHOD TO IMPROVE PACKET RATE USING PACKET BUNDLE MODE TO TRANSMIT A VECTOR OF PACKETS IN A SINGLE JOB

(71) Applicant: Marvell Asia Pte Ltd, Singapore (SG)

(72) Inventors: Sasikumar Parthiban, Livermore, CA (US); Abdul W. Mohammed, Los Gatos, CA (US); Ahmed Shahid, San Jose, CA (US); Elfarouk Badawy, San Jose, CA (US)

(73) Assignee: Marvell Asia Pte Ltd, Singapore (SG)

(21) Appl. No.: 19/358,088

(22) Filed: Oct. 14, 2025

Related U.S. Application Data
(60) Provisional application No. 63/706,911, filed on Oct. 14, 2024.

(51) Int. Cl. H04L 47/125; H04L 49/90

(52) U.S. Cl. CPC H04L 47/125; H04L 49/9068

(57) ABSTRACT

A method for bundling data packets in a single transmission job including creating a job descriptor for the transmission job based on at least one of a packet mode for the transmission job and a bundling mode for the transmission job, the job descriptor comprising a pointer to a read DMA section, the read DMA section including at least one read DMA command for fetching all of the data packets; storing the job descriptor in a memory device; enqueuing a job command associated with the job descriptor job to a hardware scheduler; and processing the job command by a transmission module by retrieving the job descriptor from the memory device; executing the at least one DMA command to fetch all of the data packets; and transmitting the data packets via the data communications system in accordance with the at least one of the packet mode and the bundling mode.

### PRIORITY APPLICATION

This patent application claims priority to and/or the benefit of U.S. Provisional Application No. 63/706,911, entitled, “Method to Improve Packet Rate with the Packet Bundle Mode to Transmit a Vector of Packets in a Single Job,” filed on Oct. 14, 2024, which U.S. Provisional Application is hereby incorporated by reference in its entirety.

### BACKGROUND

In the current implementation of the Open Radio Access Network (ORAN) fronthaul interface network interface card (NIC), packets are transmitted on a per-packet basis, which imposes significant limitations on the number of packets that can be transmitted per second (packet-per-second transmission rate) as well as on the achievable throughput for smaller packets. Packets scheduled for transmission via the fronthaul interface require a job descriptor that includes job configuration words and the list of Read (RD) Direct Memory Access (DMA) commands to read the packet header and payload from memory. A per-packet software interface such as implemented in the ORAN fronthaul interface NIC requires a significant number of computer processing unit (CPU), or compute, cycles to prepare for each packet a job descriptor and job command and to enqueue the job command to a hardware scheduler of the NIC in order to transmit the packet. Accordingly, a need has arisen to support higher packet-per-second transmission rates on the fronthaul interface NIC in a manner that minimizes CPU load, improve throughput achievable for smaller packets, and reduce overhead in the job processing framework to save power and increase efficiency.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a block diagram of an exemplary computing system, according to some embodiments of the disclosure.

FIG. 2 illustrates a block diagram of an exemplary packet transmission system, according to some embodiments of the disclosure.

FIG. 3 illustrates a more detailed block diagram of the packet transmission system of FIG. 2, according to some embodiments of the disclosure.

FIG. 4 illustrates a format of an exemplary job descriptor for use in the packet transmission system of FIG. 2, according to some embodiments of the disclosure.

FIG. 5 illustrates an exemplary transmission packet bundle, according to some embodiments of the disclosure.

FIGS. 6A and 6B illustrate a first packet bundling mode, according to some embodiments of the disclosure.

FIGS. 7A and 7B illustrate a second packet bundling mode, according to some embodiments of the disclosure.

FIGS. 8A and 8B illustrate a third packet bundling mode, according to some embodiments of the disclosure.

FIG. 9 illustrates a flow diagram of exemplary operations of a packet bundling feature implemented in the packet transmission system of FIG. 2, according to some embodiments of the disclosure.

### DETAILED DESCRIPTION

### Overview

Embodiments described herein include a technique for bundling multiple packets (e.g., a vector of up to 16 packets) to be transmitted via a single job command. As will be described in greater detail hereinbelow, a packet bundling feature of particular embodiments aids in reducing job processing overhead in a mega hardware accelerator block (MHAB) wrapper, reduces the number of CPU cycles required to prepare and enqueue jobs to a baseband physical layer (PHY) Scheduler Module, improves packet-per-second transmission rates, reduces memory usage for the job descriptor, and reduces the power necessary to transmit packets without requiring hardware changes to the NIC itself.

A job descriptor for a bundle of packets (or “packet bundle”) may include a common task configuration word, as well as packets-specific configuration words. The job read DMA list may be configured with a single DMA command (if the bundled packets, including their headers and payloads, are stored in contiguous memory) or multiple DMA commands (if the packets stored in non-contiguous memory). With multiple packets bundled in a single job, the number of Radio Fronthaul Over Ethernet (RFOE) transmission (TX) MHAB cycles required to handle operations associated with fetching per-packet job descriptors is reduced, thus improving supported packet rate and throughput. Hence, embodiments of the packet bundling feature described herein reduces the number of compute cycles taken by software to prepare a job and enqueue job commands to the PHY Scheduler Module (PSM) scheduling queue, thus reducing the number of compute cycles requirement to meet packet rate and throughput. Additionally, embodiments of the packet bundling feature described herein reduce the PSM job scheduling rate and job completion response rate.

Embodiments of the packet bundling feature described herein substantially reduce the amount of memory required to store job descriptors and the number of job descriptor configuration words and header bytes read by the MHAB from the system memory, thus reducing the amount of power required to transmit packets. When multiple packets are bundled in a single job share the same header data bytes, hardware can be configured to read header data bytes once from memory and to use the same header to create all of the packets within the bundle that share the same header bytes.

### Exemplary Computing System

Computing system 100 may include processor 102. Processor 102 may manage data processing tasks. Processor 102 can include one or more suitable types of processors, and one or more suitable number of processors. Processor 102 may be a single-core processor, or a multi-core (e.g., ARM or x86 processor cores). Examples of processor 102 may include a central processing unit (CPU), a graphics processing unit (GPU), a field-programmable gate array (FPGA), a tensor processing unit (TPU), a data processing unit (DPU), a digital signal processor (DSP), an application specific integrated circuit (ASIC), etc. Processor 102 can execute instructions or commands of an operating system. Processor 102 can perform operations and/or computations for an application of computing system 100.

Computing system 100 may include input/output interfaces 104. Input/output interfaces 104 may include one or more interfaces to facilitate communication between processor 102 and one or more external devices. Input/output interfaces 104 can include ports for connecting peripherals, such as Universal Serial Bus (USB), audio inputs/outputs, displays, and human interface devices.

Computing system 100 may include communications 106. Communications 106 may handle data network connectivity, including wired interfaces like Ethernet or fiber optic interfaces, and wireless interfaces for communication over wireless networks such as Wireless Local Area Networks (WLANs), cellular networks, and Wireless Personal Area Networks (WPANs). Examples of communications 106 include a Gigabit Ethernet port for fast wired network connections and a Wi-Fi module supporting 802.11ac for high-speed wireless internet access. Communications 106 may include NICs for supporting functionality thereof.

Computing system 100 may include computer-readable storage media 108. Computer-readable storage media 108 may include memory 110. Computer-readable storage media 108 may include media drive 112. Computer-readable storage media 108 may store instructions, when executed by processor 102, that cause processor 102 to perform one or more operations.

Memory 110 can include volatile memory. Memory 110 can include non-volatile memory. Volatile memory may include various types of random-access memory (RAM), e.g., Dynamic Random-Access Memory (DRAM) and Static Random-Access Memory (SRAM). Non-volatile memory may include Read-Only Memory (ROM), Electrically Erasable Programmable Read-Only Memory (EEPROM), and Flash memory. These memories can data associated with the application and/or the operating system executing on processor 102.

An example of media drive 112 is an HDD, which is a type of non-volatile storage device used in computing system 100 to physically store and retrieve data. Media drive 112 may include media disk assembly 120. Media disk assembly 120 may include the physical disks or platters where data is stored magnetically. Platters are circular disks coated with magnetic material where data is stored. Platters can be made of aluminum or glass and are coated with a thin layer of magnetic material. The platters are mounted on a spindle, which is rotated by a motor. The platters can be mounted on an integrated spindle and motor assembly, which rotates the disks under read/write heads 122. Media disk assembly 120 can include multiple platters, each storing data on both sides. The speed at which the platters spin is measured in revolutions per minute (RPM), with common speeds being 5400 RPM, 7200 RPM, and higher for performance drives.

Media drive 112 may include read/write heads 122. Read/write heads 122 read data from and write data to the disks. Read/write heads 122 are positioned by an actuator, floating just above the surface of the platters, to access different areas of the disk surface. The actuator may have an arm that moves the read/write heads across the platters to access different tracks and sectors. The movement is controlled by a voice coil motor, which allows precise positioning. Read/write heads 122 may include dedicated read and write elements (e.g., referred to herein as readers or writers). For instance, read/write heads 122 may include a Giant Magnetoresistive (GMR) read head that detects magnetic changes on the disk surface with high sensitivity. Read/write heads 122 may include a write head that generates magnetic fields and alters the magnetic fields on the disk surface to write data.

Media drive 112 may include preamplifier 124. Preamplifier 124 may include a preamplifier for a writer to amplify the signals to the write heads before they are used by the write heads. The preamplifier for the writer ensures that the signals are strong enough for accurate data writes. Preamplifier 124 may include a preamplifier for a reader to amplify the signals acquired by the read heads before they are processed. The preamplifier for the reader ensures that the signals are strong enough for accurate data reads/interpretation. The preamplifier for the reader can boost weak signals from the read head to a level suitable for digital processing, ensuring reliable data readback.

Media drive 112 may include controller 126. Controller 126 can manage the overall operation of media drive 112, including the movement and positioning of read/write heads 122, the processing of data signals, data encoding/decoding, and communication with the computer system. Controller 126 can include a storage media controller, servo control unit, and read/write channel. The storage media controller enables processor 102 to access contents of media disk assembly 120, such as an operating system, applications, or data for applications or other services. The storage media controller can write and read data to and from media disk assembly 120. For example, the storage media controller may manage data caching to improve read/write performance. The servo control unit can ensure precise positioning of read/write heads 122 to access specific data sectors on media disk assembly 120 and manages the encoding and decoding of data signals. The servo control unit controls mechanical operations, such as positioning of read/write heads 122 and rotational speed control through the spindle and motor assembly of media disk assembly 120. For instance, it ensures read/write heads 122 are accurately positioned over the correct track on the disk. The read/write channel includes digital-to-analog and analog-to-digital paths for converting write data to write signals or converting read signals to read data. The read/write channel processes and encodes signals when data is written to media disk assembly 120 and decodes signals when data is read from media disk assembly 120. For example, the read/write channel handles signal conditioning, sampling, equalization, phase adjustment, detection, and error correction to ensure reliable data storage and retrieval.

### Exemplary Packet Transmission System Supporting Packet Bundling Feature

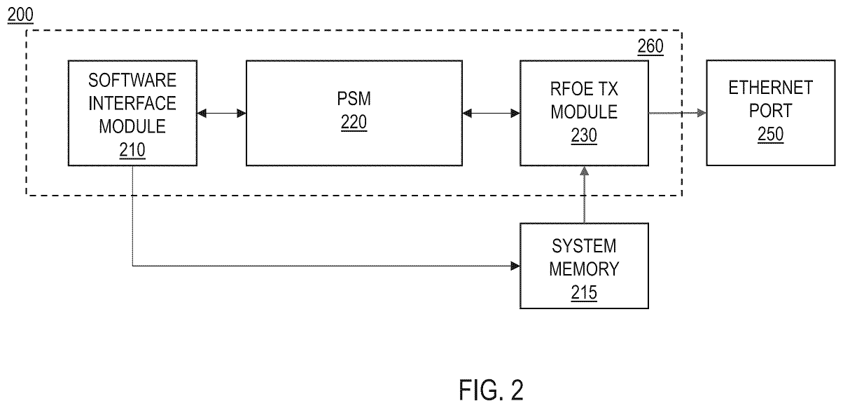

FIG. 2 illustrates packet transmission system 200, according to some embodiments of the disclosure. In some embodiments, system 200 comprises a portion of an ORAN RFOE transmission system; however, it will be recognized that embodiments described herein may find beneficial application in other types of packet transmission systems.

As shown in FIG. 2, transmission system 200 includes a software interface module 210 for preparing transmission job commands, including job descriptors associated with the commands, storing job descriptors and packets (headers and payloads) in system memory 215, and forwarding job commands to a PSM 220, which schedules job commands to be sent to a RFOE TX module 230 for processing. For each job command received, RFOE TX module 230 retrieves from system memory the corresponding job descriptor and up to N packets (header and payload) data bundled into a single job and transmits the bundle via an Ethernet port 250. It will be recognized that software interface module 210, PSM 220, and RFOE TX module 230 collectively comprise a NIC 260.

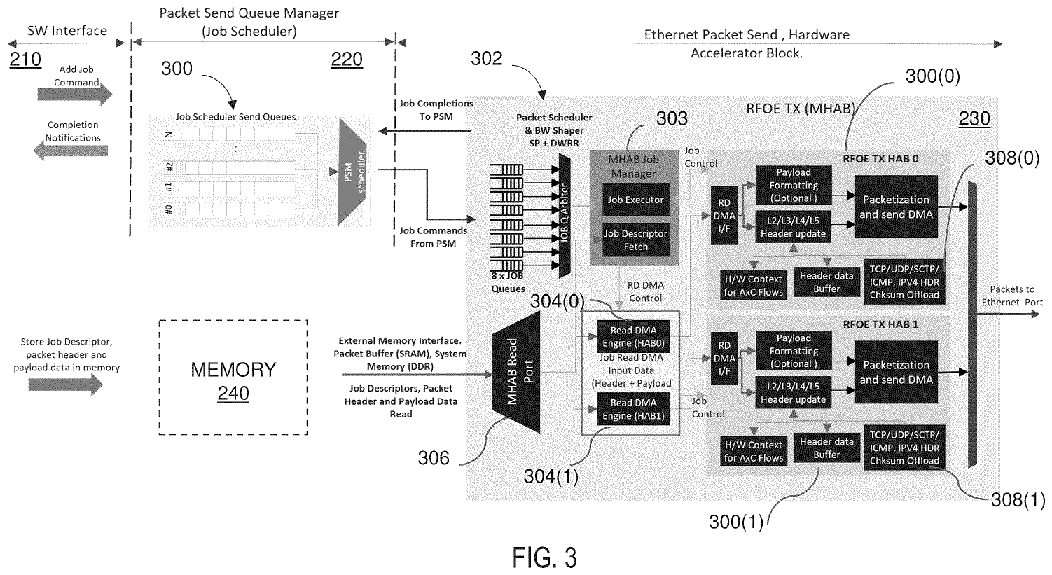

FIG. 3 illustrates a more detailed block diagram of packet transmission system 200, according to some embodiments of the disclosure. As shown in FIG. 3, PSM 220 includes a job command send queue 300 for queuing job commands received from software interface module 210 and a scheduler 302 for sending job commands stored in queue 300 to RFOE TX module 230 in accordance with a determined schedule.

In accordance with features of embodiments described herein, RFOE TX module 230 functions as a MHAB with a MHAB Wrapper (MHBW) and HABs. RFOE TX module 230 is a network interface controller supporting transmission of packets over an Ethernet interface and includes two TX HABs 300(0) and 300(1) each of which support processing an Add Job command that, in accordance with features of embodiments described herein, transmits a variable number of packets based on the job AB slot configuration words. RFOE TX module 230 provides an interface to PSM 220 to accept job commands therefrom and return job completion responses thereto and includes packet scheduler 302 including eight job queues and a bandwidth shaper providing QOS. RFOE TX module 230 further includes a MHAB job manager 303 that may manage operation of TX HABs 300(0) and 300(1) as well control read DMA engines 304(0) and 304(1) for reading job descriptors and packet data from system memory 240 via MHAB read port 306 and capable of scatter/gather of read DMA input data. RFOE TX 230 may also include hardware engines 308(0) and 308(1) for offloading L3/L4 checksum computation.

As previously noted, RFOE TX module 230 transmits a variable number of packets based on AB slot configuration word. In particular, a field NUM_BUNDLE_PKT of the AB slot configuration word (AB CFG) indicates the number of packets to be included in a particular bundle. In particular embodiments, the maximum number of packets that may be bundled is 16; however, in alternative embodiments, a different number may be selected as the maximum number of packets that may be bundled. As will be described in greater detail hereinbelow, RFOE TX module 230 supports transparent and non-transparent modes of packet transmit, with a PKT_MODE field of AB CFG defining the packet transmit mode. In particular, if PKT_MODE is equal to 1, the packet transmit mode is non-transparent, in which mode separate DMA for header and payload, update of L2-L5 header fields, offload of L3-L4 checksum, and creation of packet with header and payload data bytes put together are supported. If PKT_MODE is equal to 0, the packet transmit mode is transparent, in which the packet is transmitted as-is without any modification by the RFOE TX module 230 hardware.

### Exemplary Job Descriptor Format for Packet Bundling Feature

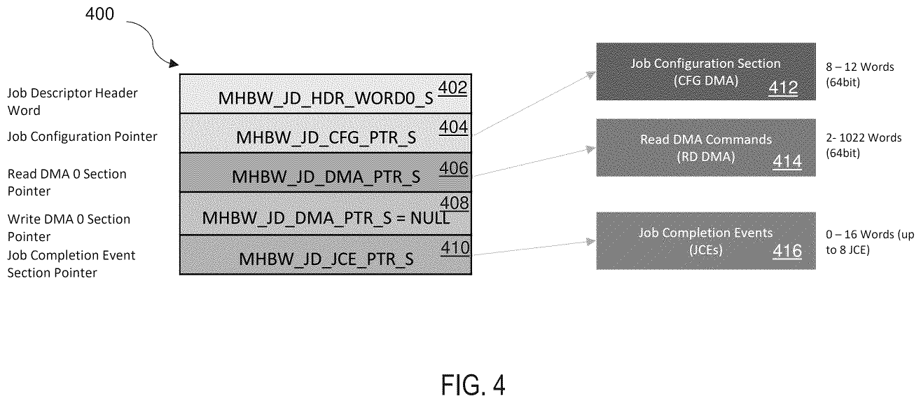

FIG. 4 illustrates the format of a job descriptor 400 according to some embodiments. As shown in FIG. 4, job descriptor 400 includes a job descriptor header word 402, a job configuration pointer 404, a read DMA 0 section pointer 406, a write DMA 0 section pointer 408, and a job completion event (JCE) section pointer 410. Configuration pointer 404 points to a job configuration section (CFG DMA) 412, which comprises 8 to 12 64 bit words. Read DMA 0 section pointer 406 points to read DMA commands for the job 414, which comprise 2 to 1022 64 bit words. Write DMA 0 section pointer 408 is unused and is therefore NULL (0×0). Finally, JCE section pointer 410 points to job completion events 416 (up to 8 JCEs), which comprise 0-16 64 bit words.

### Exemplary Packet Bundling

RFOE TX module 230 (FIG. 2), and specifically MHABs thereof, support transmission of multiple packets bundled in a single job sharing a common job configuration and per packet configuration for both transparent (PKT_MODE=0) and non-transparent (PKT_MODE=1) mode. AB Slot configuration includes Common Task Configuration words and per Packet (task) Configuration words. In particular, NUM_BUNDLED_PKT is a 5-bit field that indicates the number of packets bundled in the job within a range of 1 to 16 packets. The number of AB slot configuration words configured for a job is variable and depends on the number of packets bundled in the job. All packets bundled in the same job have a common slot configuration. Read DMA can be set up as single DMA or multiple DMAs (scatter/gather) covering all packets for transparent packet mode (PKT_MODE=0). For non-transparent packet mode (PKT_MODE=1), the value of a TX_PKT_BM field defines the bundling mode for the job, allowing software interface module 210 (FIG. 2) to set up for each packet bundled in the job a separate header read DMA or a single header read DMA for use by all packets in the bundle.

Packet bundling mode significantly saves software compute cycles by reducing the number of job descriptors that need to be prepared for sending packets; instead of preparing N job descriptors and N add job commands to send N packets, software populates a single job descriptor bundling N packets and adding a single add job command to the PSM queue to send the same N packets.

In addition to reducing the number of compute cycles required to send N packets, the packet bundling feature described herein helps to improve packet send performance, with job descriptor fetch cycles and job completion handling cycles of MHBW being shared by N packets, thus improving packet send latency and packet-per-second transmission rate.

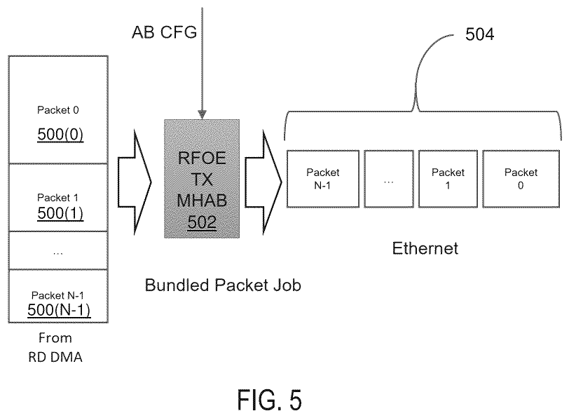

FIG. 5 illustrates bundling of N packets in accordance with features of particular embodiments. As shown in FIG. 5, N packets 500(0)-500(N-1) are read from external memory by RFOE TX MHAB 502 in accordance with an AB slot configuration word (AB CFG) and transmitted via the Ethernet as a single bundled vector 504.

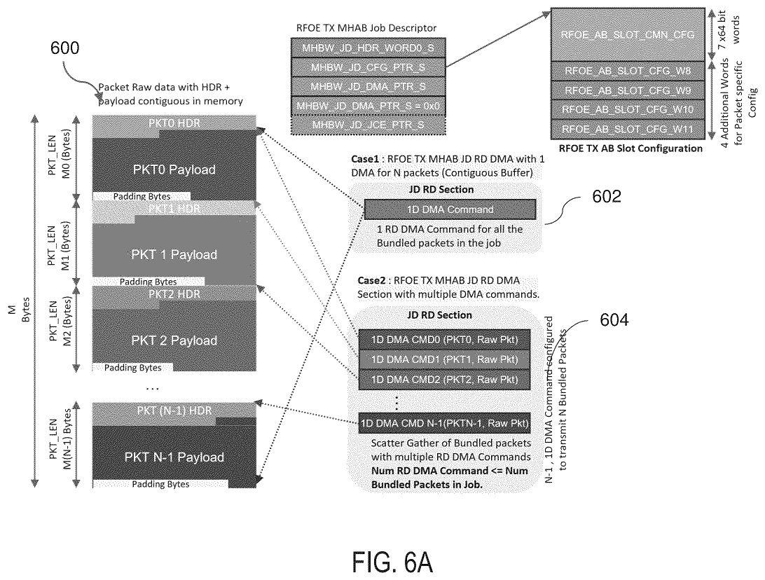

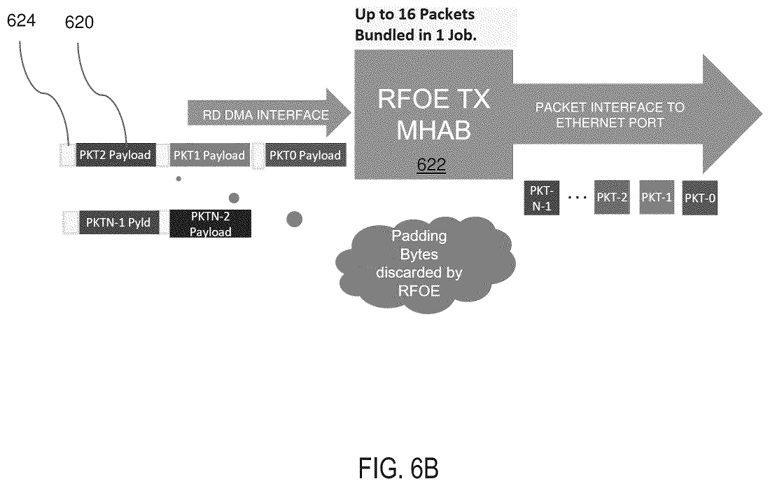

FIG. 6A illustrates transparent mode packet bundling in accordance with features of embodiments described herein. As previously noted, in transparent mode (PKT_MODE=0), all packets are sent transparently with no modifications performed by RFOE TX MAHB. Transparent mode jobs must be configured with the input data in network byte order for all packets bundled in the job. With packet bundling enabled (e.g., NUM_BUNDLE_PKT>1) in transparent mode, in a first case (Case 1) in which all of the packets 600 to be bundled are contiguous in memory, RFOE TX MHAB job descriptor read (JD RD) section 602 can be configured with a single read DMA command to transfer the N packets 600. Alternatively, in a second case (Case 2) in which packets 600 are not contiguous in memory, RFOE TX MHAB JD RD section 604 can be configured to perform scatter/gather of the bundled packets with one DMA command per bundled packet. For example, if NUM_BUNDLE_PKT=16, there will be 16 DMA commands in the JD RD section 604. It will be recognized that in Case 2, the header and payload for each packet is stored contiguously in memory.

As shown in FIG. 6B, for each packet 620 bundled in a job, input data byte streams to the RFOE TX MHAB 622 should be a multiple of 32 bytes. Depending on the value of PKTx_LEN for the packet, input data may include align padding bytes (up to 31 bytes, 256-bit read DMA port width) in the last DMA flit for the packet. RFOE TX MHAB 622 is designed to discard the padding bytes 624 present in the read DMA input bytes. In particular, RFOE TX MHAB 622 discards padding bytes at the end of each packet, with the size of the padding byte calculated based on the PKTx_LEN of each packet. When PKT_MODE=0×0, PKTx_LEN indicates the size of the packet in bytes; however, the number of bytes configured in the read DMA command for the packet may be larger than the packet length and the additional bytes (up to 31) read from memory will be discarded. The number of padding bytes discarded for each packet is calculated based on the value of PKTx_LEN for that packet.

RFOE TX module 230 also supports sending multiple packets bundled in a job configured in a non-transparent packet mode (PKT_MODE=1). For bundled packet jobs, RFOE TX module 230 supports the optional RoE/eCPRI transport header construction, VLAN TAG modifications, L3/L4 header field updates (including checksum update), and RoE payload I, Q sample width conversion.

Based on the RFOE mode and the common task configuration, all packets bundled in the same job share the same configuration, including the header DMA size HDR_LEN, pointers to outer and inner L3/L4 layer start offset, pointer to RoE/eCPRI header in header DMA bytes, VLAN TAG modification actions, outer/inner VLAN TAG value, and the CHANNEL_ID (i.e., LMAC ID). All packets bundled in the same job configured in non-transparent mode undergo a similar header modification operation; however, each packet in the job bundle can have different payload size as configured by PKTx_LEN for the packet. The number of AB configuration words set up for a RFOE TX job is variable and depends on the value of NUM_BUNDLED_PKT.

RFOE TX jobs configured in non-transparent mode (PKT_MODE=1) support flexible read DMA configurations with separate DMA commands for the header bytes and for the payload bytes. Read DMA transfer size for the header bytes of a packet should match the HDR_LEN bytes or the HDR_LEN bytes rounded to the next 32 byte boundary (RFOE TX MHAB read DMA port size is 256 bits). Read DMA transfer size for the packet payload bytes should match the PKTx_LEN bytes or the PKT_LEN bytes rounded to the next 32 byte boundary. DMA transfer size configured more than the above configuration will result into DMA error and the packet is dropped.

Flexible read DMA configuration supported in non-transparent packet mode supports two scenarios: (1) all packets bundled in the job setup with a different header data byte for each packet; or (2) all packets bundled in the job use the same header data bytes. These two scenarios (referred to as bundling modes) are supported by MHAB with a special configuration field TX_PKT_BM.

In bundling mode 0 (TX_PKT_BM=0), each packet bundled in the same the job is configured with a separate header DMA command. Though the header DMA bytes will be different for each packet, the HDR_LEN of all packets in the bundled job will be same. Each packet is set up with a separate DMA command to transfer packet payload bytes and should match the HDR_LEN bytes or the HDR_LEN bytes rounded to the next 32 byte boundary.

In bundling mode 1 (TX_PKT_BM=1), all packets in the bundled job share the same header data bytes and the first command in the read DMA commands section is configured to transfer header data bytes from memory. Each packet in the bundled job may be set up with a separate DMA command in the read DMA commands section to transfer packet payload bytes that are scattered in memory.

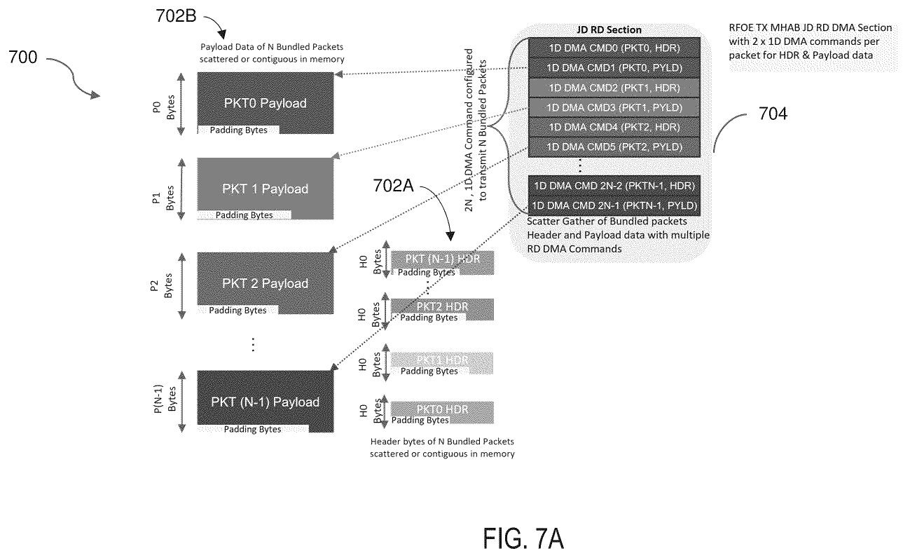

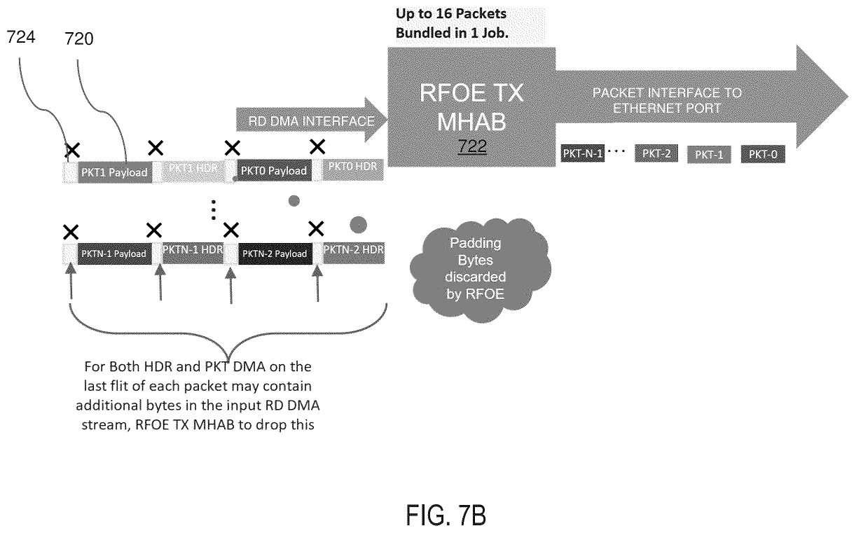

FIG. 7A illustrates non-transparent (PKT_MODE=1) RFOE TX packet bundling mode 0 (TX_PKT_BM=0) in accordance with features of embodiments described herein. RFOE TX packet bundling mode 0 allows the software interface to bundle packets 700 with different header data bytes 702A and different payload bytes 702B to be transmitted in a single RFOE TX MHAB job. As shown in FIG. 7A, RFOE TX MHAB job descriptor read (JD RD) section 704 includes for each packet in the bundle separate DMA commands to transfer header data bytes and packet payload bytes. In particular, two commands are set up for each packet, with DMA command 0 (CMD0) set up to transfer header data bytes of packet 0 (PKT0, HDR) with the DMA transfer size aligning to the HDR_LEN configuration and DMA command 1 (CMD1) set up to transfer payload data bytes of packet 0 (PKT0, PYLD) with the DMA transfer size aligning to the PKT0_LEN in AB slot configuration.

The number of DMA commands configured in RFOE TX MHAB job descriptor read (JD RD) section 704 is at least the two times the number of packets N bundled in the job. DMA commands in the RFOE TX MHAB job descriptor read (JD RD) section 704 are interleaved to deliver header and payload data bytes of packet 0 to packet (N−1) in order as shown in FIG. 7A.

Referring now to FIG. 7B, by default, for each section 720 of a packet (header or payload) RFOE TX MHAB 722 expects the read DMA transfer size BLOCK_SIZE configured in the DMA command for the header and DMA command for payload data may include padding bytes 724 up to 31 bytes in the input DMA stream. RFOE TX MHAB 722 is designed to discard the padding bytes 724 present in the input read DMA data for both HDR and payload for each packet.

BLOCK_SIZE configured for HDR and payload matches the HDR_LEN and PKTx_LEN respectively. BLOCK_SIZE in the DMA command for a packet should match the number of samples/bytes specified by PKTx_LEN. Any mismatch in the BLOCK_SIZE and the corresponding HDR_LEN or the PKTx_LEN will lead to a DMA error and the packet is marked as error which will lead to a frame check sequence (FCS) poisoning. The number of padding bytes discarded in last flit for the header DMA data and last flit for the payload DMA data is calculated with the HDR_LEN and PKTx_LEN configuration.

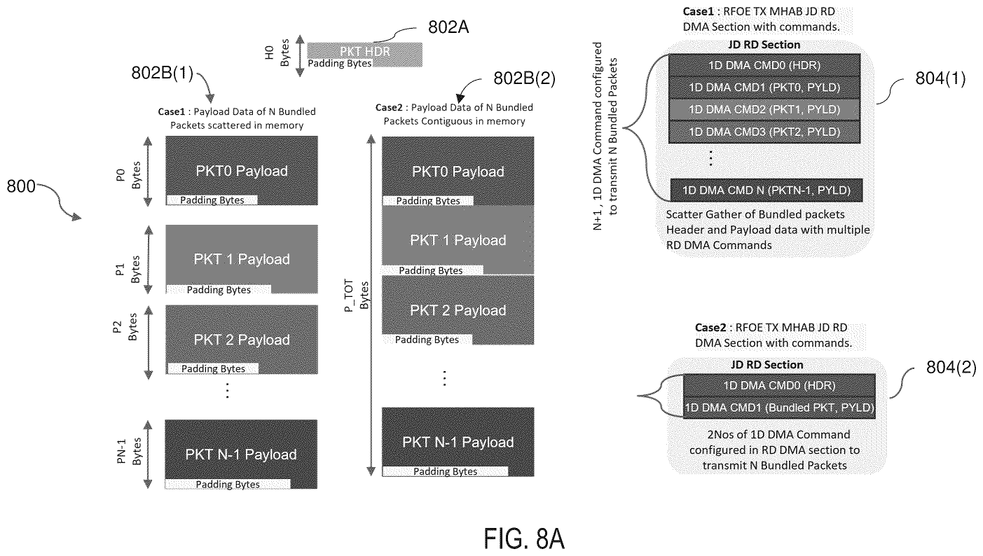

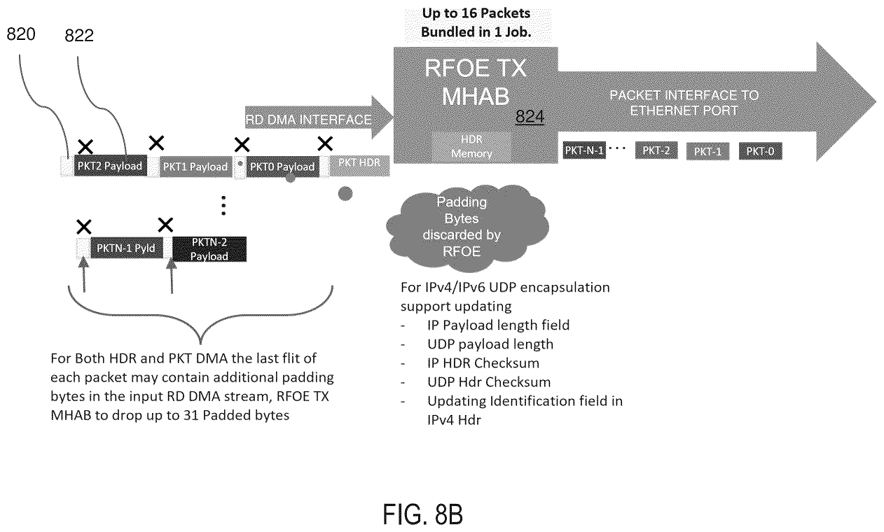

FIG. 8A illustrates non-transparent (PKT_MODE=1) RFOE TX packet bundling mode 1 (TX_PKT_BM=1) in accordance with features of embodiments described herein. RFOE TX packet bundling mode 1 allows the software interface to bundle packets 800 with the same header data bytes 802A but different payload bytes 802B(1) (packets scattered in memory (described below as Case 1)) or 802B(2) (packets contiguous in memory (described below as Case 2)) to be transmitted in a single RFOE TX MHAB job. When the job is processed, header data bytes 802B for the bundled job are read once by the first read DMA command configured in a RFOE TX MHAB job descriptor read (JD RD) section 804(1) (Case 1) or 804(2) (Case 2) and stored in internal memory (HDR memory FIG. 8B) of RFOE TX module. Each packet is created after updating header fields stored in internal memory and combining with the payload data.

With header data bytes transferred once per bundled job, packet payload data may be transferred with a separate DMA command for each packet scattered in memory (Case 1) or one DMA commands to transfer N payload packets stored contiguously (Case 2) so long as each packet starts on a 32 byte boundary (i.e., DMA transfer size for each packet must by multiple of 32 bytes and the bytes padded for alignment is discarded by RFOE TX MHAB). In both cases, the first DMA command is set up to transfer header bytes for the bundle and each packet payload data should start on a new 32 byte flit.

Referring again to Case 1 comprising a scatter/gather of payload data, as shown in RFOE TX MHAB job descriptor read (JD RD) section 804(1), DMA command 0 (CMD0) is set up to transfer header data bytes (HDR) for the bundle with the DMA transfer size aligning to the HDR_LEN configuration and may include padding of up to 31 bytes. DMA commands 1-N (CMD1-CMDN) are set up to transfer payload data bytes of packets 0 to packet N−1 (PKT0, PYLD−PKTN-1, PYLD), with the DMA transfer size BLOCK_SIZE aligning to the corresponding PKTx_LEN in the AB slot configuration. Each payload data for each packet may include padding of up to 31 bytes.

Referring again to Case 2, in which payload data is stored contiguously in memory, as shown in RFOE TX MHAB job descriptor read (JD RD) section 804(2), DMA command 0 (CMD0) is set up to transfer header data bytes for the bundle with the DMA transfer size aligning to the HDR_LEN configuration and may include padding of up to 31 bytes and DMA command 1 (CMD1) is set up to transfer payload data bytes of packet 0 to packet N−1, with the DMA transfer size BLOCK_SIZE aligning to the sum of packet length rounded to next 32 byte multiple PKT0_LEN: PKTn-1_LEN in the AB slot configuration. Each packet payload data bytes may include padding of up to 31 bytes.

Referring now to FIG. 8B, by default, the read DMA transfer size BLOCK_SIZE configured in the DMA command for the header data and DMA command(s) for the payload data may include up to 31 padding bytes 800 in the input DMA stream for each DMA chunk 822. RFOE TX MHAB 824 discards the padding bytes 800 present in the input read DMA data for both the header data and payload data of each packet. The number of padding bytes discarded in the last flit (32 byte word) for the header DMA data and last flit for the payload DMA data is calculated with the HDR_LEN and PKTx_LEN configuration for Case 1. As the header data is common for all the packets in the bundled job (Case 1), RFOE TX MHAB supports updating the payload length field in the L3/L4 header to match the PKTx_LEN configured for each packet in the AB slot configuration. In particular, in this combination of packet and bundling modes, RFOE TX MHAB supports or more of:
updating L3/L4 and eCPRI/RoE transport header fields to match the [PKTx_LEN] configured for each packet in AB slot configuration;
updating Total Length and Identification fields in IPv4 (L3) header;
updating Payload Length field in IPv6 (L3) header;
updating Length field in UDP (L4) header;
updating eCPRIPayload field or RoElength field in eCPRI or RoE (IEEE1914.3) transport header, respectively, as defined by ORAN_TR_HDR_TYPE;
updating ORAN sequence id and sub sequence if in eCPRI or RoE (IEEE1914.3) transport header
computing and updating Header Checksum in IPv4 (L3) header; and
computing and updating Checksum in UDP (L4) header.

### Exemplary Operations Performed in Connection with Packet Bundling Feature

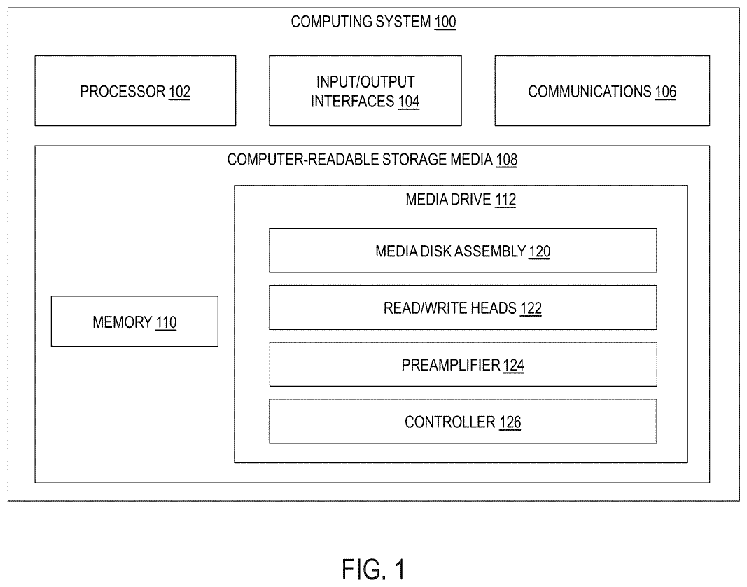

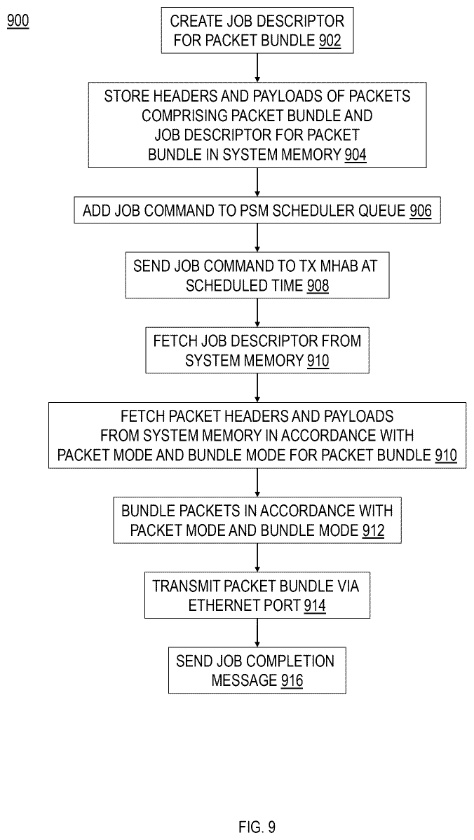

FIG. 9 depicts a flow chart illustrating a method 900 for implementing a packet bundling feature, according to some embodiments of the disclosure. Operations comprising method 900 may be performed by components illustrated in FIGS. 1-3, for example.

In operation 902, application software (i.e., software interface module) creates a job descriptor for a bundle of packets to be transmitted in a single job.

In operation 904, headers and payloads of the packets comprising the bundle of packets and the job descriptor for the packet bundle are stored in system memory.

In operation 906, a job command identifying the job descriptor for the packet bundle transmission is added to a PSM scheduler queue by application software.

In operation 908, the job command is sent to a transmission module at the scheduled time.

In operation 910, the transmission module fetches the job descriptor from system memory.

In operation 912, the transmission module DMA fetches the packet headers and payloads from system memory in accordance with a packet mode and a bundle mode identified for the job.

In operation 914, the transmission module transmits the packet bundle via an Ethernet port of the transmission module.

In operation 916, the transmission module returns a job completion message.

Although the operations of the example method shown in and described with reference to FIG. 9 are illustrated as occurring once each and in a particular order, it will be recognized that the operations may be performed in any suitable order and repeated as desired. Additionally, one or more operations may be performed in parallel. Furthermore, the operations illustrated in FIG. 9 may be combined or may include more or fewer details than described.

### SELECT EXAMPLES

Example 1 provides a method for bundling N data packets in a single job for transmission via a data communications system, in which each of the data packets includes a header and a payload, the method including creating a job descriptor for the single transmission job based on at least one of a packet mode for the single transmission job and a bundling mode for the single transmission job, the job descriptor including a pointer to a read DMA section, the read DMA section including at least one read DMA command for fetching all of the data packets; storing the job descriptor in a memory device; enqueuing a job command associated with the job descriptor job to a hardware scheduler; and processing the job command by a transmission module, the processing including retrieving the job descriptor from the memory device; executing the at least one DMA command to fetch all of the data packets; and transmitting the data packets via the data communications system in accordance with the at least one of the packet mode and the bundling mode.

Example 2 provides the method of example 1, in which the processing the job command further includes retrieving the job descriptor from the memory device; executing the at least one DMA command to fetch all of the data packets; and transmitting the data packets via the data communications system in accordance with the at least one of the packet mode and the bundling mode wherein N is greater than 1 and less than or equal to 16.

Example 3 provides the method of example 1 or 2, in which the packet mode includes a first packet mode in which, for each data packet, the header and the payload are stored contiguously.

Example 4 provides the method of example 3, in which when the packet mode includes the first packet mode and the data packets are stored contiguously to one another, the read DMA section includes a single read DMA command for fetching all of the data packets.

Example 5 provides the method of example 3 or 4, in which when the packet mode includes the first packet mode and the data packets are stored non-contiguously to one another, the read DMA section includes N DMA read commands for fetching each of the data packets individually.

Example 6 provides the method of any one of examples 1-5, in which the packet mode includes a second packet mode and the bundling mode includes a first bundling mode in which at least one of the headers is different than remaining ones of the headers.

Example 7 provides the method of example 6, in which when the packet mode includes the second packet mode and the bundling mode includes the first bundling mode, the read DMA section includes N read DMA commands for fetching all of the headers and N read DMA commands for fetching all of the payloads.

Example 8 provides the method of example 7, in which the N read DMA commands for fetching all of the payloads are interleaved with the N read DMA commands for fetching all of the headers.

Example 9 provides the method of any one of examples 1-8, in which the packet mode includes a second packet mode and the bundling mode includes a second bundling mode in which all of the headers are identical.

Example 10 provides the method of example 9, in which when the packet mode includes the second packet mode, the bundling mode includes the second bundling mode, and the payloads are stored non-contiguously, the read DMA section includes N+1 read DMA commands for fetching a single one of the headers and all of the payloads.

Example 11 provides the method of example 9 or 10, in which when the packet mode includes the second packet mode, the bundling mode includes the second bundling mode, and the payloads are stored contiguously, the read DMA section includes two read DMA commands for fetching a single one of the headers and all of the payloads.

Example 12 provides a network interface controller (NIC) configured to bundle multiple data packets in a single transmission job, in which each of the packets includes a header and a payload, the NIC including an application software module configured to: create a job descriptor for the single transmission job based on at least one of a packet mode for the single transmission job and a bundling mode for the single transmission job, the job descriptor including a pointer to a read DMA section, the read DMA section including at least one read DMA command for fetching all of the data packets; and store the job descriptor in a memory device; and a physical layer scheduler module (PSM), in which the PSM receives from the application software module a job command associated with the job descriptor job, the PSM configured to enqueue the job command; and a transmit module configured to receive the job command from the PSM and, subsequent to receipt of the job command: retrieve the job descriptor from the memory device; execute the at least one DMA command to fetch all of the data packets; transmit the data packets via a data communications system in accordance with the at least one of the packet mode and the bundling mode; and return a job completion event to the software module subsequent to the transmitting; in which N is greater than 1 and less than or equal to 16.

Example 13 provides the NIC of example 12, in which the packet mode includes a first packet mode in which, for each data packet, the header and the payload are stored contiguously.

Example 14 provides the NIC of example 13, in which: if the packet mode includes the first packet mode and the data packets are stored contiguously to one another, the read DMA section includes a single read DMA command for fetching all of the data packets; and if the packet mode includes the first packet mode and the data packets are stored non-contiguously to one another, the read DMA section includes a N DMA read commands for fetching each of the data packets individually.

Example 15 provides the NIC of any one of examples 12-14, in which if the packet mode includes a second packet mode, and the bundling mode includes a first bundling mode in which at least one of the headers is different than remaining ones of the headers, the read DMA section includes N read DMA commands for fetching all of the headers and N read DMA commands for fetching all of the payloads.

Example 16 provides the NIC of any one of examples 12-15, in which the packet mode includes a second packet mode and the bundling mode includes a second bundling mode in which all of the headers are identical.

Example 17 provides the NIC of example 16, in which: if the packet mode includes the second packet mode, the bundling mode includes the second bundling mode, and the payloads are stored non-contiguously, the read DMA section includes N+1 read DMA commands for fetching a single one of the headers and all of the payloads; and if the packet mode includes the second packet mode, the bundling mode includes the second bundling mode, and the payloads are stored contiguously, the read DMA section includes two read DMA commands for fetching a single one of the headers and all of the payloads.

Example 18 provides one or more non-transitory computer-readable media storing instructions that, when executed by one or more processors, cause the one or more processors to implement operations for bundling N data packets in a single job for transmission via a data communications system, in which each of the data packets includes a header and a payload, the operations including creating a job descriptor for the single transmission job based on at least one of a packet mode for the single transmission job and a bundling mode for the single transmission job, the job descriptor including a pointer to a read DMA section, the read DMA section including at least one read DMA command for fetching all of the data packets; storing the job descriptor in a memory device; enqueuing a job command associated with the job descriptor job to a hardware scheduler; processing the job command by a transmission module, the processing including retrieving the job descriptor from the memory device; executing the at least one DMA command to fetch all of the data packets; transmitting the data packets via the data communications system in accordance with the at least one of the packet mode and the bundling mode; and returning a job completion event subsequent to the transmitting.

Example 19 provides one or more non-transitory computer-readable media of example 18, in which the packet mode includes a first packet mode in which, for each data packet, the header and the payload are stored contiguously and in which: if the packet mode includes the first packet mode and the data packets are stored contiguously to one another, the read DMA section includes a single read DMA command for fetching all of the data packets; and if the packet mode includes the first packet mode and the data packets are stored non-contiguously to one another, the read DMA section includes a N DMA read commands for fetching each of the data packets individually.

Example 20 provides one or more non-transitory computer-readable media of example 18 or 19: in which if the packet mode includes a second packet mode, and the bundling mode includes a first bundling mode in which at least one of the headers is different than remaining ones of the headers, the read DMA section includes N read DMA commands for fetching all of the headers and N read DMA commands for fetching all of the payloads; and in which if the packet mode includes the second packet mode and the bundling mode includes a second bundling mode in which all of the headers are identical: if the packet mode includes the second packet mode, the bundling mode includes the second bundling mode, and the payloads are stored non-contiguously, the read DMA section includes N+1 read DMA commands for fetching a single one of the headers and all of the payloads; and if the packet mode includes the second packet mode, the bundling mode includes the second bundling mode, and the payloads are stored contiguously, the read DMA section includes two read DMA commands for fetching a single one of the headers and all of the payloads.

### Variations and Other Notes

The detailed description, such as the “Select examples” section, provide various examples of the embodiments disclosed herein.

As used herein, the term “coupled to” or “coupled with” refers to a relationship between electronic components or circuit elements wherein the components are in electronic communication with one another and capable of transmitting and/or receiving electrical signals between them. The term “coupled to” does not require a direct physical or electrical connection between the coupled components. Rather, “coupled to” can encompass arrangements where the components are connected through one or more intervening elements, components, circuits, or transmission paths. For example, a first component may be “coupled to” a second component through intermediate components such as resistors, capacitors, inductors, transistors, logic gates, buses, transformers, or other electronic components, or through intermediate transmission paths, while still maintaining the capability for electronic communication between the first and second components.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

What is claimed is:

1. A method for bundling N data packets in a single job for transmission via a data communications system, wherein each of the data packets comprises a header and a payload, the method comprising:
creating a job descriptor for the single transmission job based on at least one of a packet mode for the single transmission job and a bundling mode for the single transmission job, the job descriptor comprising a pointer to a read DMA section, the read DMA section including at least one read DMA command for fetching all of the data packets;
storing the job descriptor in a memory device;
enqueuing a job command associated with the job descriptor job to a hardware scheduler; and
processing the job command by a transmission module.

2. The method of claim 1, wherein the processing the job command further comprises:
retrieving the job descriptor from the memory device;
executing the at least one DMA command to fetch all of the data packets; and
transmitting the data packets via the data communications system in accordance with the at least one of the packet mode and the bundling mode.

3. The method of claim 1, wherein the packet mode comprises a first packet mode in which, for each data packet, the header and the payload are stored contiguously.

4. The method of claim 3, wherein when the data packets are stored contiguously to one another, the read DMA section includes a single read DMA command for fetching all of the data packets.

5. The method of claim 3, wherein when the data packets are stored non-contiguously to one another, the read DMA section includes N DMA read commands for fetching each of the data packets individually.

6. The method of claim 1, wherein the packet mode comprises a second packet mode and the bundling mode comprises a first bundling mode in which at least one of the headers is different than remaining ones of the headers.

7. The method of claim 6, wherein the read DMA section includes N read DMA commands for fetching all of the headers and N read DMA commands for fetching all of the payloads.

8. The method of claim 7, wherein the N read DMA commands for fetching all of the payloads are interleaved with the N read DMA commands for fetching all of the headers.

9. The method of claim 1, wherein the packet mode comprises a second packet mode and the bundling mode comprises a second bundling mode in which all of the headers are identical.

10. The method of claim 9, wherein when the payloads are stored non-contiguously, the read DMA section includes N+1 read DMA commands for fetching a single one of the headers and all of the payloads.

11. The method of claim 9, wherein when the payloads are stored contiguously, the read DMA section includes two read DMA commands for fetching a single one of the headers and all of the payloads.

12. A network interface controller (NIC) configured to bundle multiple data packets in a single transmission job, wherein each of the packets comprises a header and a payload, the NIC comprising:
an application software module configured to:
create a job descriptor for the single transmission job based on at least one of a packet mode for the single transmission job and a bundling mode for the single transmission job, the job descriptor comprising a pointer to a read DMA section, the read DMA section including at least one read DMA command for fetching all of the data packets; and
store the job descriptor in a memory device; and
a physical layer scheduler module (PSM), wherein the PSM receives from the application software module a job command associated with the job descriptor job, the PSM configured to enqueue the job command; and
a transmit module configured to receive the job command from the PSM and, subsequent to receipt of the job command:
retrieve the job descriptor from the memory device;
execute the at least one DMA command to fetch all of the data packets;
transmit the data packets via a data communications system in accordance with the at least one of the packet mode and the bundling mode; and
return a job completion event to the software module subsequent to the transmitting;
wherein N is greater than 1 and less than or equal to 16.

13. The NIC of claim 12, wherein the packet mode comprises a first packet mode in which, for each data packet, the header and the payload are stored contiguously.

14. The NIC of claim 13, wherein:
if the data packets are stored contiguously to one another, the read DMA section includes a single read DMA command for fetching all of the data packets; and
if the data packets are stored non-contiguously to one another, the read DMA section includes a N DMA read commands for fetching each of the data packets individually.

15. The NIC of claim 12, wherein if the packet mode comprises a second packet mode and the bundling mode comprises a first bundling mode in which at least one of the headers is different than remaining ones of the headers, the read DMA section includes N read DMA commands for fetching all of the headers and N read DMA commands for fetching all of the payloads.

16. The NIC of claim 12, wherein the packet mode comprises a second packet mode and the bundling mode comprises a second bundling mode in which all of the headers are identical.

17. The NIC of claim 16, wherein:
if the payloads are stored non-contiguously, the read DMA section includes N+1 read DMA commands for fetching a single one of the headers and all of the payloads; and
if the payloads are stored contiguously, the read DMA section includes two read DMA commands for fetching a single one of the headers and all of the payloads.

18. One or more non-transitory computer-readable media storing instructions that, when executed by one or more processors, cause the one or more processors to implement operations for bundling N data packets in a single job for transmission via a data communications system, wherein each of the data packets comprises a header and a payload, the operations comprising:
creating a job descriptor for the single transmission job based on at least one of a packet mode for the single transmission job and a bundling mode for the single transmission job, the job descriptor comprising a pointer to a read DMA section, the read DMA section including at least one read DMA command for fetching all of the data packets;
storing the job descriptor in a memory device;
enqueuing a job command associated with the job descriptor job to a hardware scheduler;
processing the job command by a transmission module, the processing comprising:
retrieving the job descriptor from the memory device;
executing the at least one DMA command to fetch all of the data packets;
transmitting the data packets via the data communications system in accordance with the at least one of the packet mode and the bundling mode; and
returning a job completion event subsequent to the transmitting.

19. One or more non-transitory computer-readable media of claim 18, wherein the packet mode comprises a first packet mode in which, for each data packet, the header and the payload are stored contiguously and wherein:
if the data packets are stored contiguously to one another, the read DMA section includes a single read DMA command for fetching all of the data packets; and
if the data packets are stored non-contiguously to one another, the read DMA section includes a N DMA read commands for fetching each of the data packets individually.

20. One or more non-transitory computer-readable media of claim 18:
wherein if the packet mode comprises a second packet mode and the bundling mode comprises a first bundling mode in which at least one of the headers is different than remaining ones of the headers, the read DMA section includes N read DMA commands for fetching all of the headers and N read DMA commands for fetching all of the payloads; and
wherein if the packet mode comprises the second packet mode and the bundling mode comprises a second bundling mode in which all of the headers are identical:
if the payloads are stored non-contiguously, the read DMA section includes N+1 read DMA commands for fetching a single one of the headers and all of the payloads; and
if the payloads are stored contiguously, the read DMA section includes two read DMA commands for fetching a single one of the headers and all of the payloads.
